(19) United States
(12) Patent Application Publication
(10) Pub. No.: US 2002/0081405 A1
(43) Pub. Date: Jun. 27, 2002

(54) Process for manufacturing a multi-layer packaging film

(76) Inventors: Claude A. Marbler, Phalsbourg (FR); Frederic Froemer, Sarrebourg (FR)

Correspondence Address: Fisher Christen & Sabol, Suite 1401, 1725 K Street, N.W., Washington, DC, 20006, US

(21) Appl. No.: 09/996,739

(22) Filed: Nov. 30, 2001

(30) Foreign Application Priority Data
Dec. 21, 2000 (EP) 00811227.8

(51) Int. Cl. B32B 1/02

(52) U.S. Cl. 428/35.2; 428/43; 156/253

(57) ABSTRACT

A process for manufacturing a multi-layer packaging film (10) for an easy-open form of packaging (20), having at least one line of perforations (18, 18′) which are provided in a plastic surface layer of the packaging and serve as an aid for alignment of a tear line propagating in the packaging film (10) on tearing open the packaging, is such that the perforations (18, 18′) are cut into a surface layer which is in the form of a film (14) and the said pre-cut film (14) is joined to the other layers (12) to make up a composite film (10).

The invention relates to a process for manufacturing a multi-layer packaging film for an easy-open form of packaging having at least one line of perforations which are provided in a plastic surface layer of the packaging and serve as an aid for alignment of a tear line propagating in the packaging film on tearing open the packaging. Also within the scope of the invention is a form of packaging comprised at least in part of the packaging film and the use of the packaging film for pouch-type forms of packaging.

Known from document WO-A-9829312 is a multi-layer packaging film for pouch-type forms of packaging. The packaging film is comprised of two plastic layers and a light metal layer arranged between the plastic layers. The outer lying plastic layers may be of a single plastic layer or in the form of a laminate comprised of several layers or films. The plastic layer in the packaging film which later faces the contents of the packaging is provided with two lines of perforations running parallel to each other and a distance apart. The perforations are produced by a laser beam melting the plastic film down to the middle layer of metal. In a pouch-type form of packaging made from the packaging film, and featuring two packaging films that are joined together forming a sealing seam at an edge running round the packaging, a tearing notch is provided at the edge of the pouch in such a manner that on tearing open the packaging a tear forms and propagates between the two lines of perforations, and is guided by these as the packaging is torn open further.

Document EP-A-0 540 184 reveals a multi-layer packaging film made of thermo-plastics with a reflecting metal strip on one of the surfaces of the pouch. Two lines of perforations running towards each other from both sides of the packaging film are produced using a laser beam.

A packaging film known from document U.S. Pat. No. 5,000,321 is comprised of an aluminium foil coated on both sides with plastic. For the purpose of guiding the tear through the packaging film on tearing open the packaging made of the said film, the packaging film is weakened at the intended tear line by linear removal of the plastic layer on both sides using a laser beam.

A state-of-the-art multi-layer packaging film with lines of perforations as a guide for a tear created on tearing open a form of packaging made from the packaging film is such that the guidelines are made by a laser beam exclusively on the finished packaging film. By partial separation of an outer plastic layer to create the perforations with a laser beam, the parameters which lead to evaporation of the plastic must be maintained with extreme exactness in order that the perforations on the one hand are not too weak and, on the other hand, that there is no complete through separation of the composite film. Creating a guideline by mechanical cutting e.g. with a knife is for the same reasons practically not possible.

The object of the invention is therefore to provide a process of the kind mentioned at the start, by means of which the lines of perforations can be produced already during the manufacture of the multi-layer packaging film, this in a simple manner and without employing a laser beam.

That objective is achieved by way of the invention in that the perforations are cut into a surface layer which is in the form of a film and the said cut film is joined to further layers to make up a composite film.

The required depth of the perforations is guaranteed as complete penetration of the film takes place. As the perforations are created before production of the multi-layer composite film, penetration of the packaging film is excluded from the start.

Basically in the process according to the invention it is also possible to employ a laser beam as cutting tool; any other suitable form of cutting tool may, however, be employed e.g. a roller blade or a knife.

In a first version the film is joined to other layers to make up a composite film using an adhesive layer.

The cutting of the perforations may take place before or after coating the film with an adhesive layer.

In an alternative version the film is joined to the other layers by extrusion to make up the composite film.

Usefully, two lines of perforations are cut essentially parallel and a distance apart from each other as guidelines on both sides of a crack propagating in the packaging film on tearing open the packaging.

In the case of packaging made from the packaging film e.g. a pouch-type form of packaging, the film with the perforations in it is preferably situated on the inside of the packaging.

Further, a tearing notch is preferably provided in the region of the perforations. Where two lines of perforations are provided, the tearing notch is usefully situated such that the tear propagating in the packaging film runs between the two lines of perforations.

Further advantages, features and details of the invention are revealed in the following description of exemplified embodiments and with the aid of the drawing which shows schematically in

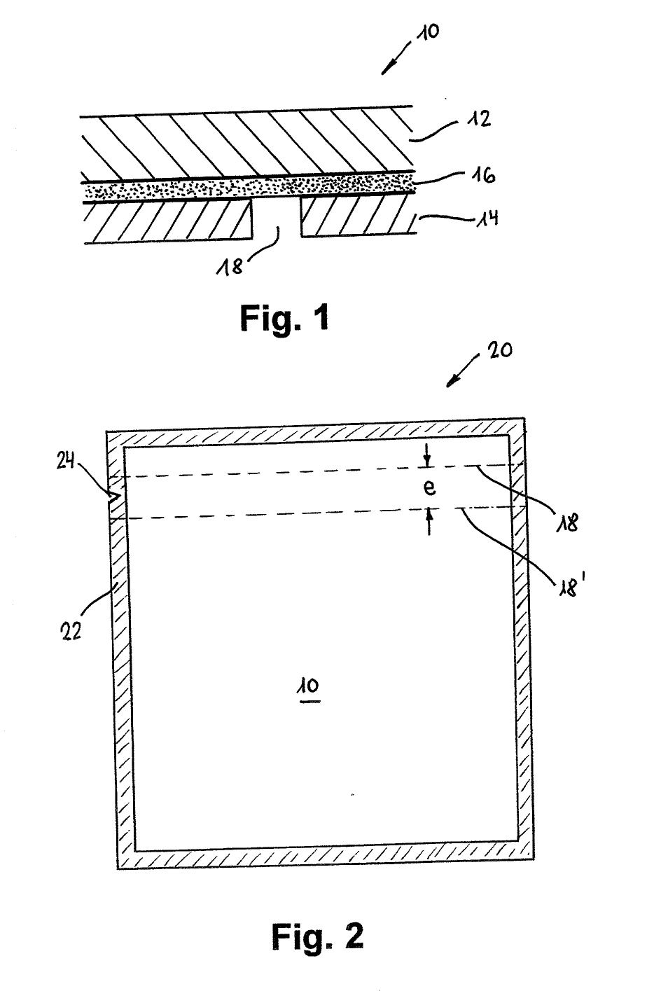

FIG. 1 a cross-section through a packaging film;

FIG. 2 the plan view of a pouch manufactured from the packaging film shown in FIG. 1.

A packaging film 10 shown in FIG. 1 has an outer layer 12 of e.g. polyethylene-terephthalate (PET) and a layer 14 e.g. of polyethylene (PE) which later in the packaging faces the contents. The inner layer 14 is bonded to the outer layer 12 e.g. via an adhesive layer 16 e.g. of polyurethane (PU) basis. In an alternative version the inner layer 14 is joined to the outer layer 12 by extrusion.

The production of the packaging film shown in FIG. 1 is such that first the inner layer 14 is available in strip form and lines of perforations 18 are cut into it using a cutting device. The pre-cut inner layer 14 is then joined to the outer layer 12 to make the packaging film 10. Thereby, the layer of adhesive 16 may if desired already be present on the inner layer 14 before the cutting is performed.

A type of packaging in the form of a pouch 20 shown in FIG. 2 is comprised essentially of two packaging films 10 which are superimposed on each other and are joined at the edge forming a sealing seam 22 which runs round the whole pouch 20. Two lines of perforations 18, 18′ run parallel to each other and a distance e, for example 3 mm, apart in the region where the opening of the pouch is intended to take place. A notch 24 for initiating the tearing action is provided in the seam 22 at the edge of the pouch, between the two lines of perforations 18, 18′. The tear that results on opening the packaging propagates in the packaging film 10 between the two lines of perforations 18, 18′ thus leading to a defined opening in the pouch 20.

The make-up of a multi-layer packaging film 10 shown in FIG. 1 is to be regarded only as an example. Both the outer layer 12 and the inner layer 14 may themselves have a multi-layer structure. The process according to the invention for manufacturing generally known multi-layer packaging films with integral aid to tearing in the form of lines of perforations for a tear propagating in the packaging film on tearing open the packaging is to a large degree independent of the particular plastics chosen and the overall make-up of the packaging film.

1. Process for manufacturing a multi-layer packaging film (10) for an easy-open form of packaging (20) having at least one line of perforations (18, 18′) which are provided in a plastic surface layer of the packaging and serve as an aid for alignment of a tear line propagating in the packaging film (10) on tearing open the packaging, characterised in that
the perforations (18, 18′) are cut into a surface layer which is in the form of a film (14) and the said pre-cut film (14) is joined to the other layers (12) to make up a composite film (10).

2. Process according to claim 1, characterised in that the film (14) is joined to the other layers (12) by way of an adhesive layer (16) to make up a composite film (10).

3. Process according to claim 2, characterised in that the perforations (18, 18′) are cut before coating the film (14) with adhesive (16).

4. Process according to claim 2, characterised in that the perforations (18, 18′) are cut after coating the film (14) with adhesive (16).

5. Process according to claim 1, characterised in that the film (14) is joined to the other layers (12) by means of extrusion to make up a composite film (10).

6. Process according to one of the claims 1 to 5, characterised in that two lines of perforations (18, 18′) are cut essentially parallel to each other and a distance (e) apart as guidelines on both sides of a tear which propagates in the pack-aging film (10) on tearing open the packaging (20).

7. Process according to one of the claims 1 to 6, characterised in that the packaging film is employed for the production of pouch-type forms of packaging.

8. Packaging comprised at least in part of a packaging film (10) manufactured using the process according to one of the claims 1 to 7.

9. Packaging according to claim 8, characterised in that the film (14) with the perforations (18, 18′) is situated on the inner side of the packaging.

10. Packaging according to claim 8 or 9, characterised in that a notch (24) for initiating tearing is provided in the region of the perforations (18, 18′).

11. Packaging according to claim 10, characterised in that the notch (24) is situated between the two lines of perforations (18, 18′).
